(19) United States
(12) Patent Application Publication
(10) Pub. No.: US 2010/0148555 A1
(43) Pub. Date: Jun. 17, 2010

(54) Welfare Seat Equipment and Seat Moving Device

(75) Inventors: Ching-Yung Lung, JhuDong Township (TW); Hsiu-Chu Shen, Xinzhuang City (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: Red Heart Enterprise Co., Ltd., Sinjhuang City (TW)

(21) Appl. No.: 12/636,895

(22) Filed: Dec. 14, 2009

(30) Foreign Application Priority Data
Dec. 16, 2008 (TW) 097222568

(51) Int. Cl. B60N 2/24; A47C 1/00; B60N 2/14; B60N 2/04; A61G 3/04

(52) U.S. Cl. 297/344.14; 248/419

(57) ABSTRACT

The invention discloses a seat moving device including a first mounting base, a seat first mounting arm, a first supporting arm, a second supporting arm, and a motor member. A seat can be carried by the seat mounting arm. The first supporting arm and the second supporting arm are engaged with the first mounting base and the seat mounting arm. The motor member drives the first supporting arm to rotate relatively to the first mounting base, so as to drive the seat mounting arm and the second supporting arm to rotate relatively to the mounting base.

### BACKGROUND OF THE INVENTION

1. Field of the Invention

The present invention relates to a seat moving device, and more particularly, to a welfare seat equipment for moving a seat of a vehicle to make the disabled get on/off vehicles easily.

2. Description of the Prior Art

In some modern cities, there are many facilities/public infrastructures in daily life to assist the disabled in using public infrastructures or accessing public area as normal people. In order to promote the idea of barrier-free space for the disabled, to reduce the inconvenience in the daily life, and to expand the living space of the disabled, the barrier-free equipments should be set not only in the building (for example, set a ramp on the stairs, and set handrails in the toilets, etc.), but also in vehicles to assist the disabled to access the vehicles. Therefore, going out may not be a trouble for the disabled.

Because the disabled may have difficulties in walking, or may not able to walk by themselves, when they travel to a place in the distance and cannot reach the place by the wheelchair, they can only get there by cars, vans or rehab buses. Except for the rehab buses, most of other types of vehicles are with small doors, limited inside space, and a gap between the floor of the vehicles and the ground. It is so inconvenient for the disabled to get on/off the vehicles, and the disabled usually need other people's help.

At present, the structures of welfare seat equipments used to assist the disabled to get on/off the vehicles are complicated. In general, the traditional welfare seat equipment disposed in the vehicles is designed to perform two-stage movement. For example, the welfare seat equipment of the prior art carries the seat to get inside/outside of the vehicles in horizontal direction and than carries the seat from the floor/ground to the ground/floor in vertical direction, to let the disabled get on/off the seat. However, the two-stage welfare seat equipment needs to operate in horizontal and vertical direction separately. Therefore, it is hard to shorten the operation time efficiently. Beside, the structure of the two-stage welfare seat equipment is complicated, such that the welfare seat equipment occupies large volume.

Therefore, the invention provides a welfare seat equipment which can assist the disabled to get on and off vehicles quickly and easily.

### SUMMARY OF THE INVENTION

A scope of the present invention is to provide a seat moving device for moving a seat to an expected position in one step to save the operation time.

In an embodiment, the seat moving device of the present invention comprises a first mounting base, a seat mounting arm, a first supporting arm, a second supporting arm and a motor member. The seat mounting arm is used to carry a seat. The first supporting arm and the second supporting arm both are engaged with the first mounting base and the seat mounting arm. The motor member is used to drive the first supporting arm to rotate relatively to the first mounting base, so as to drive the seat mounting arm and the second supporting arm to rotate relatively to the first mounting base.

In addiction, the seat moving device further comprises a second mounting base, and the first mounting base is disposed on the second mounting base and able to rotate relatively to the second mounting base to increase the dimension (direction) of movement. Moreover, the seat moving device further comprises a third mounting base, and the second mounting base is disposed on the third mounting base and able to move relatively to the third mounting base to increase the distance of movement.

Another scope of the present invention is to provide a welfare seat equipment for moving a seat to an expected position in one step to save the operation time.

In an embodiment, the welfare seat equipment of the invention comprises a seat and a seat moving device. The components of the seat moving device and how they work are as described above, and discussion of unnecessary details will be hereby omitted.

Therefore, the welfare seat equipment of the present invention can achieve the purpose of moving the seat by using a four-bar linkage mechanism (the first mounting base, the seat mounting arm, the first supporting arm and the second supporting arm). Because the seat rotates relatively to the first mounting base, the seat can be moved in horizontal (forward and backward) direction and in vertical (up and down) direction at the same time. Thus, the welfare seat equipment of the present invention can carry the disabled from inside of the vehicles to the ground without moving in horizontal and vertical direction separately to save the time while getting on and off the vehicles.

The objective of the present invention will no doubt become obvious to those of ordinary skill in the art after reading the following detailed description of the preferred embodiment, which is illustrated in the various figures and drawings.

### BRIEF DESCRIPTION OF THE APPENDED DRAWINGS

FIG. 1 shows a schematic diagram of a welfare seat equipment according to an embodiment of the invention.

FIG. 2 is a schematic diagram of the seat moving device in FIG. 1.

FIG. 3 shows a schematic diagram of a welfare seat equipment according to another embodiment of the invention.

FIG. 4 shows the second mounting base and the third mounting base of the welfare seat equipment in FIG. 3 according to an embodiment of the invention.

### DETAILED DESCRIPTION OF THE INVENTION

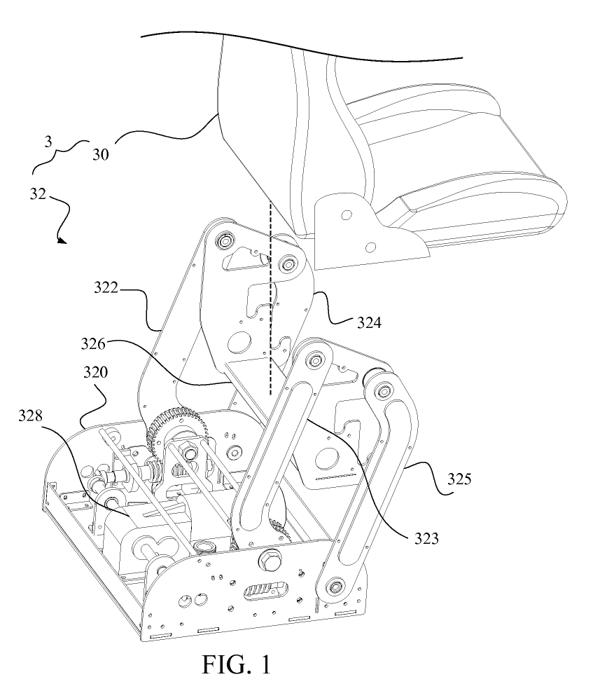

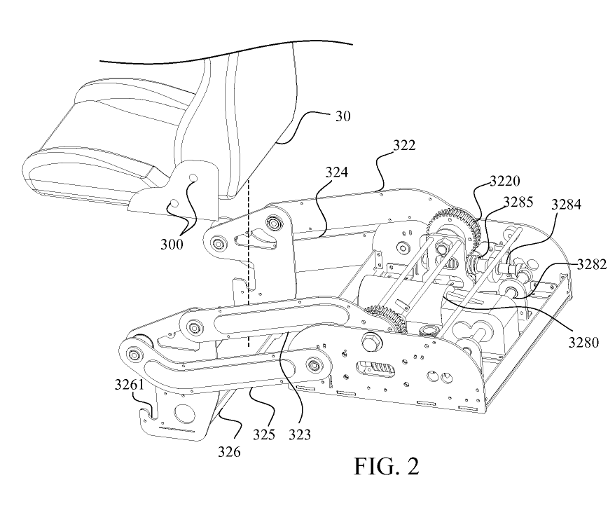

Please refer to FIG. 1 and FIG. 2, FIG. 1 shows a schematic diagram of a welfare seat equipment 3 according to an embodiment of the invention. As shown in FIG. 1, the welfare seat equipment 3 of the present invention comprises a seat 30 and a seat moving device 32. FIG. 2 is a schematic diagram of the seat moving device 32 in FIG. 1.

As shown in FIG. 1 and FIG. 2, the seat moving device 32 comprises a first mounting base 320, a first supporting arm 322, a second supporting arm 324, a seat mounting arm 326 and a motor member 328. The seat 30 is disposed on the seat mounting arm 326. The first supporting arm 322 and the second supporting arm 324 are both engaged with the seat mounting arm 326 and the first mounting base 320. The motor member 328 is disposed on the first mounting base 320.

As shown in FIG. 1 and FIG. 2, the seat mounting arm 326, the first supporting arm 322, the second supporting arm 324 and the first mounting base 320 work as a four-bar linkage mechanism. The motor member 328 drives the first supporting arm 322 to rotate relatively to the first mounting base 320, so as to drive the seat mounting arm 326 and the second supporting arm 324 to rotate relatively to the first mounting base 320.

As shown in FIG. 2, the motor member 328 comprises a motor 3280, a first transmission shaft 3282 and a second transmission shaft 3284. More specifically, in the embodiment, the motor 3280 drives the first transmission shaft 3282 to rotate the second transmission shaft 3284, and the first transmission shaft 3282 and the second transmission shaft 3284 both comprise bevel gears engaged with each other. Therefore, the first transmission shaft 3282 can drive the second transmission shaft 3284 to rotate. The second transmission shaft 3284 further comprises a worm gear 3285, and the first supporting arm 322 comprises a worm wheel 3220 engaged with the worm gear 3285. Therefore, the second transmission shaft 3284 can drive the worm wheel 3220 to rotate. In other words, the second transmission shaft 3284 can drive the first supporting arm 322 to rotate relatively to the first mounting base 320.

In practice, as shown in FIG. 1 and FIG. 2, the seat moving device 32 further comprises a third supporting arm 323 and a fourth supporting arm 325 connected between one side of the first mounting base 320 and one end of the seat mounting arm 326. The third supporting arm 323, the fourth supporting arm 325, the seat mounting arm 326 and the first mounting base 320 work as another four-bar linkage mechanism. Therefore, the motor member 328 drives the first supporting arm 322 and the third supporting arm 323 to rotate relatively to the first mounting base 320 simultaneously, so as to drive the seat mounting arm 326, the second supporting arm 324 and the fourth supporting arm 325 to rotate relatively to the first mounting base 320 simultaneously. In addiction, the seat mounting arm 326 of the invention can maintain the horizontal level of the seat 30 during the moving or rotating processes, so the user may feel steady while sitting on the seat 30.

Please note that, two sets of four-bar linkage mechanism, for carrying and moving the seat 30, are disposed in the seat moving device 3 shown in FIG. 1 and FIG. 2 to enhance the stability while moving the seat 30 and the capability to carry weight. However, the seat moving device 3 still can work normally with only one set of four-bar linkage mechanism. For example, in the absence of the third supporting arm 323 and the fourth supporting arm 325, the first supporting arm 322 and the second supporting arm 324 can be engaged with the central part of the seat mounting arm 326 and the central part of the first mounting base 320. Accordingly, the first supporting arm 322 and the second supporting arm 324 can support and engage with the seat mounting arm 326 efficiently, so as to maintain the stability of the seat mounting arm 326.

Because the first supporting arm 322 and the second supporting arm 324 are rigid bodies, the track of movement of the seat 30 is close to an arc. In other words, the position of the seat 30 in FIG. 1 and FIG. 2 can be changed in horizontal direction and in vertical direction at the same time, that is, the seat 30 disposed on the seat mounting arm 326 can perform two-dimensional movement. In practice, if the welfare seat equipment 3 in FIG. 1 and FIG. 2 is disposed in vehicles, the seat 30 can be moved into or out from the vehicles through the rear door of the vehicles. Otherwise, if the seat 30 in FIG. 1 and FIG. 2 is rotated 90 degrees and disposed on the seat mounting arm 326, the seat 30 can be moved in horizontal direction and in vertical direction at the same time, and the seat 30 can be moved into or out from the vehicles through the side doors of the vehicles.

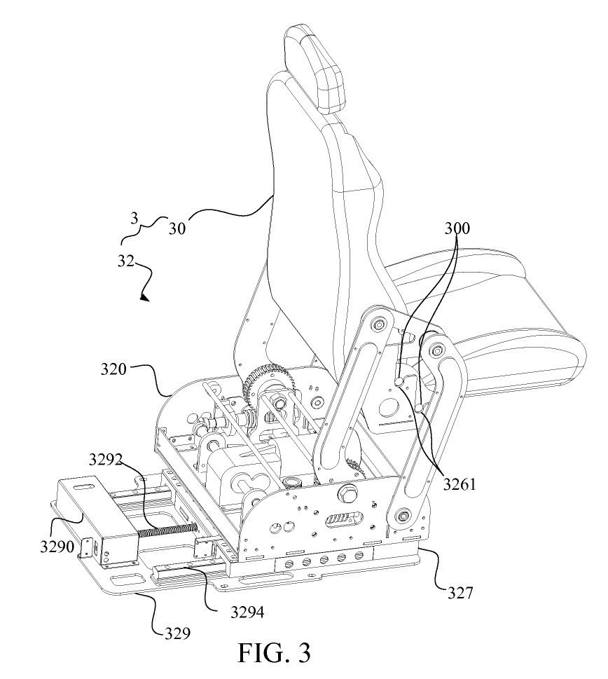

Furthermore, as shown in FIG. 2 and FIG. 3, by engaging a removable linkage part 300 of the seat 30 with the seat mounting arm 326, the seat 30 of the present invention can be disposed on or removed from the seat mounting arm 326 rapidly. Both sides of the seat mounting arm 326 have several special-designed linkage sockets 3261, and the linkage sockets 3261 can be engaged with the linkage part 300 of the seat 30 correspondingly, so as to remove or dispose the seat 30 easily.

Compare to the two-stage moving mechanism of the traditional welfare seat equipment, the four-bar mechanism of the welfare seat equipment 3 of the present invention is more compact, and it occupies smaller volume. For example, the two-stage welfare seat equipment of the prior art carries the seat to get outside of the vehicle in horizontal direction and then carries the seat to the ground in vertical direction. However, the welfare seat equipment 3 of the present invention lets the seat 30 can perform two-dimensional movement (can be moved in horizontal direction and in vertical direction at the same time) by the four-bar linkage mechanism, so as to move the seat 30 to an expected position in one step to save the operation time.

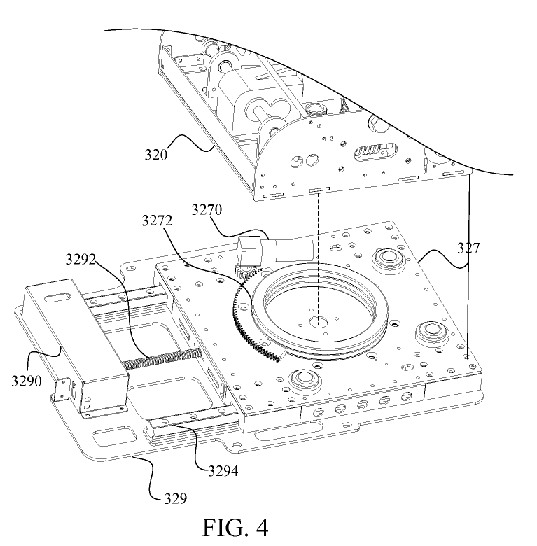

In order to enhance the moving ability (moving direction and dimension) of the welfare seat equipment 3 of the present invention, the welfare seat equipment 3 can further comprise a second mounting base 327 and a third mounting base 329, as shown in FIG. 3 and FIG. 4. FIG. 3 shows a schematic diagram of the welfare seat equipment 3 according to another embodiment of the invention. FIG. 4 shows the second mounting base 327 and the third mounting base 329 of the welfare seat equipment 3 in FIG. 3. Please refer to the following description about how can the second mounting base 327 and the third mounting base 329 enhance the moving ability of the welfare seat equipment 3.

As shown in FIG. 3 and FIG. 4, the first mounting base 320 is disposed on the second mounting base 327. The second mounting base 327 comprises a motor 3270 and a rotatable engaging ring 3272, and the first mounting base 320 joints the engaging ring 3272. The motor 3270 can drive, through the gears, the engaging ring 3272 to rotate. Therefore, the first mounting base 320 can rotate relatively to the second mounting base 327. As mentioned above, the welfare seat equipment 3 in FIG. 1 and FIG. 2 can perform two-dimensional movement. Furthermore, by adding the second mounting base 327, the welfare seat equipment 3 in FIG. 3 and FIG. 4 can perform three-dimensional movement.

Moreover, as shown in FIG. 3 and FIG. 4, the second mounting base 327 is disposed on the third mounting base 329. The third mounting base 329 comprises a motor 3290, a transmission part 3292 and a slide rail 3294, the second mounting base 327 is engaged with the slide rail 3294 and the transmission part 3292. The transmission part 3292 has first threads and the second mounting base 327 has second threads engaged with the first threads. Therefore, when the transmission part 3292 rotates, the second mounting base 327 can be pushed or pulled. In this way, when the motor 3290 drives the transmission part 3292 to rotate, the second mounting base 327 can slide on the slide rail 3294 of the third mounting base 329, that is to say, the second mounting base 327 can move relatively to the third mounting base 329. Accordingly, by adding the third mounting base 329, the moving distance and the moving ability of the welfare seat equipment 3 of the present invention can be increased.

To sum up, the second mounting base 327 and the third mounting base 329 in FIG. 3 and FIG. 4 are used to increase the direction and the distance of movement, and each of them has an independent motor. In other words, the mounting bases (the first mounting base 320, the second mounting base 327 and the third mounting base 329) can operate independently, such that the welfare seat equipment 3 of the invention can perform three-dimensional movement (up and down, forward and backward, right and left) at the same time without limitations. Accordingly, the moving direction and distance of the welfare seat equipment of the present invention can be adjusted in accordance with the opening types of the doors of various vehicles and the ways to get on/off the vehicles. Therefore, the welfare seat equipment of the present invention can be widely used in different kinds of vehicles.

As mentioned above, the seat 30 of the embodiments of the invention can be disposed on the seat mounting arm 326, and the disabled can sit on the seat 30 directly. In practice, the seat 30 can be a wheelchair for the disabled, and the seat mounting arm 326 can be designed to carry the wheelchair. In this way, the welfare seat equipment can be disposed in a general bus to let the disabled get on and off the bus quickly while sitting on the wheelchair.

Compared with the prior art, the welfare seat equipment of the present invention can achieve the purpose of moving seats by using a four-bar mechanism (the first mounting base, the seat mounting arm, the first supporting arm, the second supporting arm). Because the seat rotates relatively to the first mounting base, the seat can move in horizontal direction and in vertical direction at the same time. Thus, the welfare seat equipment of the present invention can carry the disabled from inside of the vehicles to the ground in one step without moving in horizontal and vertical direction separately, so as to save the time for getting on/off the vehicles.

In addiction, the moving dimension (direction) of the welfare seat equipment of the invention can be increased by engaging the second mounting base with the first mounting base; whereas the moving distance of the welfare seat equipment of the invention can be increased by engaging the third mounting base with the second mounting base. Accordingly, the welfare seat equipment of the invention can move without limitations and the moving range of the same can be increased, so as to assist the disabled to get on/off the vehicles.

Although the present invention has been illustrated and described with reference to the preferred embodiment thereof, it should be understood that it is in no way limited to the details of such embodiment but is capable of numerous modifications within the scope of the appended claims.

What is claimed is:

1. A seat moving device for moving a seat, the seat moving device comprising:
a first mounting base;
a seat mounting arm for carrying the seat;
a first supporting arm engaged with the first mounting base and the seat mounting arm;
a second supporting arm engaged with the first mounting base and the seat mounting arm; and
a motor member driving the first supporting arm to rotate relatively to the first mounting base, so as to drive the seat mounting arm and the second supporting arm to rotate relatively to the first mounting base.

2. The seat moving device of claim 1, further comprising:
a third supporting arm engaged with the first mounting base and the seat mounting arm; and
a fourth supporting arm engaged with the first mounting base and the seat mounting arm;
wherein the motor member drives the first supporting arm and the third supporting arm simultaneously to rotate relatively to the first mounting base, so as to drive the seat mounting arm, the second supporting arm and the fourth supporting arm simultaneously to rotate relatively to the first mounting base.

3. The seat moving device of claim 1, wherein the first supporting arm comprises a first gear, and the motor member comprises a second gear engaged with the first gear, for driving the first gear to rotate.

4. The seat moving device of claim 1, further comprising a second mounting base, wherein the first mounting base is disposed on the second mounting base and is able to rotate relatively to the second mounting base.

5. The seat moving device of claim 4, further comprising a third mounting base, wherein the second mounting base is disposed on the third mounting base and is able to rotate relatively to the third mounting base.

6. A welfare seat equipment, comprising:
a seat; and
a seat moving device comprising:
a first mounting base;
a seat mounting arm for carrying the seat;
a first supporting arm engaged with the first mounting base and the seat mounting arm;
a second supporting arm engaged with the first mounting base and the seat mounting arm; and
a motor member driving the first supporting arm to rotate relatively to the first mounting base, so as to drive the seat mounting arm and the second supporting arm to rotate relatively to the first mounting base.

7. The welfare seat equipment of claim 6, further comprising:
a third supporting arm engaged with the first mounting base and the seat mounting arm; and
a fourth supporting arm engaged with the first mounting base and the seat mounting arm;
wherein the motor member drives the first supporting arm and the third supporting arm simultaneously to rotate relatively to the first mounting base, so as to drive the seat mounting arm, the second supporting arm and the fourth supporting arm simultaneously to rotate relatively to the first mounting base.

8. The welfare seat equipment of claim 6, wherein the first supporting arm comprises a first gear, and the motor member comprises a second gear engaged with the first gear, for driving the first gear to rotate.

9. The welfare seat equipment of claim 6, further comprising a second mounting base, wherein the first mounting base is disposed on the second mounting base and is able to rotate relatively to the second mounting base.

10. The welfare seat equipment of claim 9, further comprising a third mounting base, wherein the second mounting base is disposed on the third mounting base and is able to rotate relatively to the third mounting base.

11. The welfare seat equipment of claim 6, wherein the seat mounting arm comprises a linkage socket, and the seat comprises a linkage part detachably engaged with the linkage socket.
